(19) United States
(12) Patent Application Publication
(10) Pub. No.: US 2025/0229509 A1
(43) Pub. Date: Jul. 17, 2025

(54) SELF-REPAIRING MULTILAYER MATERIALS

(71) Applicant: CompPair Technologies SA, Lausanne (CH)

(72) Inventors: Robin Trigueira, Haute-Nendaz (CH); Cecilia Scazzoli, Lausanne (CH); Amaël Cohades, Nyon (CH); Véronique Michaud, Saint-Saphorin-sur-Morges (CH)

(73) Assignee: CompPair Technologies SA, Lausanne (CH)

(21) Appl. No.: 18/727,663

(22) PCT Filed: Jan. 6, 2023
(86) PCT No.: PCT/IB2023/050105

§ 371 Date: Jul. 9, 2024

(30) Foreign Application Priority Data
Jan. 11, 2022 (CH) CH000034/2022

(51) Int. Cl. B32B 27/08; B32B 3/12; B32B 7/12; B32B 21/08; B32B 27/06; B32B 27/14; B32B 37/06; B32B 38/00

(52) U.S. Cl. CPC B32B 27/08; B32B 3/12; B32B 7/12; B32B 21/08; B32B 27/065; B32B 27/14; B32B 37/06; B32B 38/00; B32B 2038/0076; B32B 2250/02; B32B 2250/05

(57) ABSTRACT

The present invention relates to a multilayer material (1) comprising a plurality of layers (10, 10′, 20) associated with one another by means of an inserted film (30, 30′) that is suitable for restoring or reinforcing the adhesion of the layers during a heating operation, the film (30, 30′) comprising one or more first component(s) (31) forming an assembly of particles, and one or more second component(s) (32) forming a homogeneous assembly around the particles of the first component(s) (31). The second components (32) have a fluidisation temperature (Tf32) that is less than the decomposition temperature (Td31) of the first component(s) (31) and less than the decomposition temperature (Td10, Td20) of the other layers of the multilayer material. The dimension of at least 70% or at least 80% or from 70% to 90% of the particles of the first component(s) (31) is between 0.1 micrometres and 15 micrometres. The invention also relates to a method for manufacturing a material of this kind, and also to a method for repairing or restoring the adhesion of the layers. The invention further relates to an object comprising a multilayer material of this kind, and to a method for maintaining an object of this kind.

### TECHNICAL FIELD

The present invention relates to a multilayer material in which two contiguous layers are associated via an interlayer film. The multilayer material may relate to a sandwich material comprising a core material and a skin material. The interlayer film has self-regenerating or self-repairing properties of the multilayer material, in particular with regard to the cohesion of the layers.

### STATE OF THE ART

Composite materials are increasingly used in sectors such as aeronautics, the marine, turbines, wind turbines and other devices linked to energy generation and storage, as well as in other sectors linked for example to sports equipment, medical devices or automobiles. They have the advantage of high mechanical strength combined with low density, which makes it possible to considerably lighten the devices that contain them without affecting their performance.

An important challenge is to maintain the qualities of such composite materials, so as to maintain their performance for as long as possible while limiting the cost and duration of maintenance or renovation operations. More durable materials also help minimize waste associated with discarding them, as well as the resources needed to manufacture new replacement materials.

Document US20090191402 describes flexible materials comprising vesicles of reactive products, which when they degrade, release their contents and thus generate spontaneous repair of the materials. This technology is, however, not applicable to all materials, in particular to rigid materials, the degradation of which does not necessarily imply the rupture of such vesicles.

Document WO2020049516 proposes a composite material comprising a mixture of thermosetting and thermoplastic products suitable for repairing possible defects in the structure of the materials. Heating that can be local and limited makes it possible to reinforce the structure of the material and to maintain its use in the best conditions, without involving handling such as dismantling and remodeling the damaged part. Such materials are commonly referred to as self-healing, or self-repairing. The constituents of the composite materials allowing their repair are integrated into their mass.

There are however other types of materials, such as multilayer or so-called sandwich materials, made up of several distinct layers joined to each other. Each of the layers of such materials may comprise or be made up of composite materials or other materials such as natural products or plastics or foams, or metals. It is important to be able to maintain and regenerate the cohesion of the layers of such materials in order to prolong their use and performance.

There is therefore scope to develop new solutions making it possible to repair and/or regenerate such multilayer materials, in particular solutions specially adapted to such multilayer materials.

### BRIEF SUMMARY OF THE INVENTION

One aim of the present invention is to provide a multilayer material having the capacity to be self-regenerated or self-repaired. In particular, an objective of the present invention is to provide a multilayer material whose cohesion of the layers can be reinforced or repaired according to a self-regeneration or self-repair process.

Another aim of the invention is to propose a method for manufacturing a multilayer material having the capacity to be self-regenerated or self-repaired.

Another object of the present invention is to propose a method making it possible to reinforce the cohesion of the layers of such a multilayer material or to repair possible delaminations in a simple and effective manner.

Another object of the present invention is to propose a method for monitoring and maintaining an object comprising or consisting of a multilayer material.

Another object of the present invention is to propose an object whose maintenance and/or repair operations are simplified, more economical, and/or faster.

According to the invention, these aims are achieved in particular by means of the material and the manufacturing and repair methods which are the subject of the independent claims and detailed through the claims which depend thereon. In particular, the material according to the present invention is a multilayer material comprising at least a first layer and at least a second layer. The first and second layers can each be arranged in parallel planes. They are associated with each other by means of one or more films interposed between said first and second layers. The film comprises one or more first components forming, or capable of forming, an assembly of particles and one or more second components forming, or capable of forming, a homogeneous assembly around the particles of the first component(s). The second component(s) have a fluidisation temperature that is less than the decomposition temperature or the glass transition temperature of the first component(s) and less than the decomposition temperature of the first and second layers. The dimension of at least 70% or at least 80%, or from 70% to 90% of the particles of the first component(s) is comprised between 0.1 micrometres and 15 micrometres.

This solution has in particular the advantage over the prior art of allowing easy and rapid maintenance and/or restoration of multilayer materials, and in particular the cohesion of the different layers of such a material.

### BRIEF DESCRIPTION OF THE FIGURES

Examples of embodiments of the invention are indicated in the description illustrated by the following figures:

FIG. 1: example of multilayer material according to one embodiment of the present description;

FIG. 2: example of multilayer material according to another embodiment of the present description;

FIG. 3: example of multilayer material according to another embodiment of the present description;

FIG. 4: details of a film according to the present invention;

FIGS. 5A, 5B: result of a repair operation on a multilayer material according to the present description;

FIGS. 6 and 7: comparative adhesion results;

FIGS. 8 and 9: comparative results of mechanical resistance.

Example(s) of embodiments of the invention

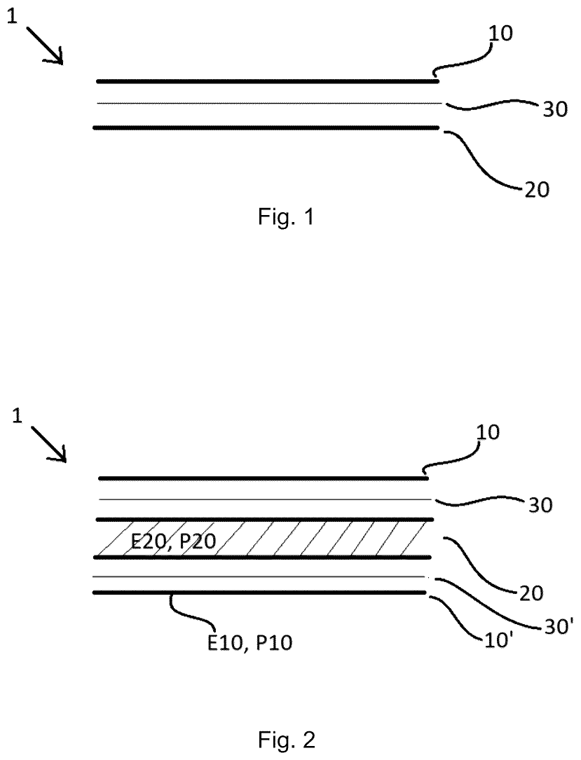

The multilayer material 1 according to the present description designates any material comprising at least one first layer 10 and at least one second layer 20, each arranged in parallel planes. According to one embodiment illustrated for example in FIGS. 1 and 2, the adjacent layers are associated with one another by means of a film 30 interposed between them. The film 30 can act as an adhesive agent. In this case, one or more of the constituents of the film 30 is able to adhere to the surface of the two adjacent layers, or to migrate in their structure close to their surface, so as to ensure cohesion. The material described here preferably designates a rigid material, i.e. having its own shape, whether two-dimensional or three-dimensional. In other words, the materials described here exclude flexible structures such as inflatable structures.

The terms “self-regeneration” and “self-repair” used in the present description when applied to the materials described herein designate any operation of repair or regeneration of the material by means of at least localized heating, even of low intensity and of short duration. These terms correspond to the language usually applied, although the material does not regenerate spontaneously in the absence of such a heating operation.

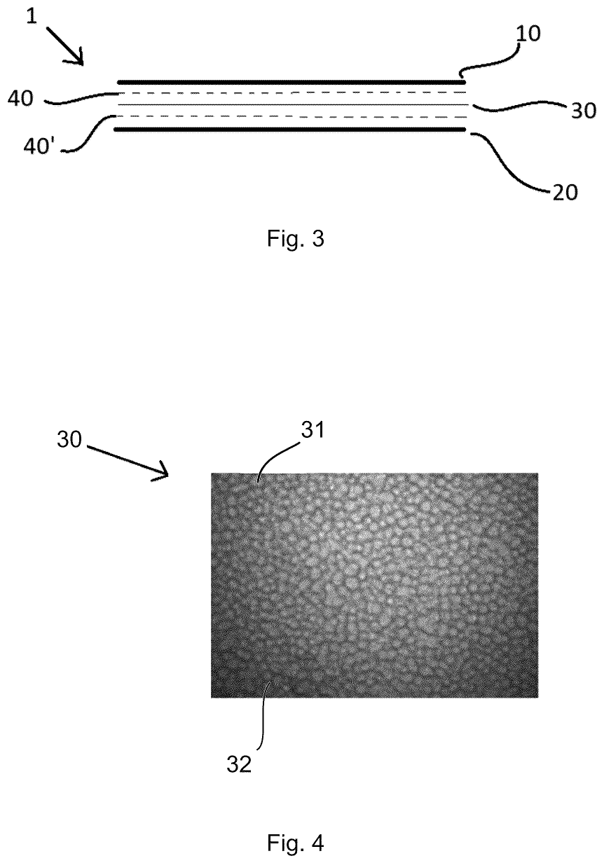

According to another possible embodiment, illustrated for example by FIG. 3, a layer of an adhesive agent 40, 40′, distinct from the interlayer film 30 can be interposed between one of the surfaces of the first 10 and second 20 layers and the film 30, or between the film 30 and each of the two surfaces facing the adjacent layers. The layer of adhesive agent 40, 40′, where appropriate, can be applied to the surface of one of the first 10 and second 20 layers or both. Alternatively, the adhesive agent can be integrated into either of the first 10 and second 20 layers. For example, either or both of the first 10 and second 20 layers may be materials pre-impregnated with an adhesive agent forming either of the layers 40, 40′ on the surface. In 25 this case, the adhesive agent allows the cohesion of the film 30 and the two adjacent layers.

It is understood that one or the other of the first 10 and second 20 layers, or both, may themselves comprise several sub-layers or several distinct structures combined with each other. In this case, they are free of interlayer film 30 which is the subject of this description and are each considered as a single layer.

One or the other of the first 10 and second 20 layers, or both, may comprise or be made up of composite materials, which may themselves comprise one or more constituents making it possible to regenerate or repair possible defects in their internal structure. Such composite materials are for example those described in document WO2020049516. The self-healing properties of these materials are in this case limited to their internal zones. The constituents allowing such self-regenerating properties, however, remain ineffective with regard to the repair or regeneration of the cohesion of several of these materials. The interlayer film 30, subject of this description and developed for this purpose, remains necessary to do this.

The first 10 and second 20 layers can be of very varied nature. They can be selected independently from one another from polymers such as plastics, rigid or flexible, metals or metal alloys, composite materials which may include reinforcing fibers, such as materials based on fibers of glass or carbon, glass, silicate, sapphire or any other material of interest. The first 10 and/or second 20 layers may for example be transparent and comprise organic polymers such as polycarbonates. The first 10 and/or second 20 layers may be of planar structure. Their facing surfaces can be either smooth or rough with equal or, on the contrary, different roughness. Alternatively, one or both of the first 10 and second 20 layers may be textured, that is to say, have a three-dimensional shape. A three-dimensional shape is understood as any relief inscribed on the surface of the layers considered or any transverse structure perpendicular to the plane of the first 10 and second 20 layers. Such a three-dimensional shape can for example be obtained by embossing one or both of these layers, or by streaks or any other suitable means. A three-dimensional shape can designate, according to another example, a honeycomb structure or any other alveolar structure. In this case, the walls of the cells can be arranged orthogonally to the plane of the first 10 and second 20 layers. The thickness of the first 10 and second 20 layers may be identical, comparable or significantly different. The thickness of two adjacent layers may differ, for example, by a ratio of between 1 and 100 or between 1 and 50 or between 1 and 10. Any other difference in thickness can be considered, as needed. The porosity of adjacent layers may be identical, comparable or significantly different. The porosity of two adjacent layers can for example be in a ratio between 1 and 1000, or between 1 and 100 or between 1 and 10.

Although the multilayer materials are described here as planar, in reality they include any three-dimensional shape, particularly conducive to aerodynamics, hydrodynamics, mechanical resistance or simply aesthetic aspects. The multilayer materials according to the present invention are therefore not limited to flat panels. Their three-dimensional shape can be obtained by the prevailing methods and practices in the field.

According to one embodiment, a multilayer material 1 according to the present description may comprise a first layer 10 of thickness E10 and porosity P10 and a second layer 20 of thickness E20 and porosity P20. The thickness P20 of the second layer 20 represents 2 to 50 times, or 3 to 30 times or 5 to 15 times the thickness P10 of the first layer 10. Alternatively, or additionally, the first layer 10 is of low porosity, in other words of high density, and the second layer is of higher porosity, i.e. of lower density. The porosity P20 of the second layer 20 can be for example 2 to 100 times, or 3 to 50 times, or 5 to 20 times greater than the porosity P10 of the first layer 10. The second layer 20 can be for example an expanded material such as a foam or an alveolar structure and the first layer can be for example a compact hard plastic, based on epoxy resin or any other resin such as those comprising a thermosetting one, or a thermoplastic one, or a mixture of the two.

Any other thickness ratio and/or porosity ratio is of course possible depending on needs. Preferably, the first 10 and second 20 layers of the multilayer material 1 according to the present description are of a different nature from one another.

According to a particular embodiment illustrated by FIG. 2, the multilayer material 1 according to the present description is a so-called sandwich material comprising two first layers 10, 10′ arranged on either side of a second layer 20. In this case, at least one film 30 is placed between one of the two first layers 10, 10′ and the second layer 20. Preferably, two films 30, 30′ are arranged on either side of the second layer 20, between the opposite surfaces of the second layer 20 and that of the two first layers 10, 10′ facing each other. The composition of the two films 30, 30′ may be identical or different. A sandwich material is not necessarily limited to a set of two first outer layers 10, 10′ and a second inner layer 20. For example, more than a single second layer, internal to the multilayer material 1, can be considered. Alternatively, or additionally, several first 10 and second 20 layers can be combined in an alternate manner. Generally speaking, the first layer(s) 10, 10′ are described as the skin of the multilayer material 1 and the second layer(s) 20 are described as the heart or body or core of the multilayer material 1.

As indicated above, the film 30 or the different films 30, 30′ interposed between the first 10 and second 20 layers aims to allow or facilitate the repair of a delamination between the first 10 and second 20 layers which are adjacent to it or to prevent such delamination. In the context of the present invention, delamination denotes any degradation of cohesion between two adjacent layers. The degradation of cohesion can be accompanied by a deformation, or a separation of the two layers. In this case, a fracture between the two layers can be identified, at least locally. The separation of two contiguous layers can for example materialize through the formation of a hollow zone between two layers, due to local compression, or a local depression of one or the other of the layers, for example due to a shock. Alternatively, local swelling may be the cause of the separation of two contiguous layers, for example following internal gas release after exposure to high temperature, or due to the effects of differential expansion of the layers. The swelling and/or non-elastic compression of the different elements of the multilayer material 1 may or may not be visible on the surface of the material.

Repeated and/or intensive use of the multilayer material 1, relating for example to static stresses and/or fatigue of the material, can also lead to more or less extensive delaminations of the layers which compose it. For example, mechanical stresses such as bending, torsion, shearing, or thermal stresses due to a difference in thermal coefficient between the two layers, can weaken the cohesion of the layers.

Aging can also contribute to weakening the cohesion of the layers, in particular due to progressive chemical degradation of the different constituents. Depending on the nature of the materials considered, aging can be caused by exposure to UV or other electromagnetic radiation, by exposure to cycles of different temperatures.

A combination of several of these factors can accelerate delamination.

Alternatively or in addition, the film 30 or the different films 30, 30′ interposed between the first 10 and second 20 layers aims to reinforce the cohesion between two contiguous layers in the absence of visible delamination. Even in the case where the multilayer material 1 has not suffered any apparent damage, the cohesive force of the adjacent layers may decrease over time, in particular due to micro-fractures or microcracks, and/or chemical degradation of the cohesive forces. In this case, the properties of the multilayer material 1 may become degraded. Cohesion defects can furthermore intensify and lead to visible degradation of the multilayer material 1. In the latter case, the repair and/or renovation operations may become insufficient to restore the initial properties of the multilayer material 1. It is then necessary to prevent this damage as best as possible before it becomes too significant.

The film 30, 30′ is prepared separately from the multilayer material 1. In other words, the first 10 and second 20 layers are prepared independently of the film 30, 30′ and then assembled so as to sandwich the film. The manufacture of the film 30, 30′ may nevertheless include one or more other steps after its assembly with the first 10 and second 20 layers. To this end, it advantageously has sufficient cohesion to remain intact during handling. That is to say, it is sufficiently strong not to tear or degrade when it is incorporated into all the other layers of the multilayer material 1. Alternatively or additionally, the film 30, 30′ can be supported on a support film (not shown) adapted to facilitate its handling. Such a support can be a polymer film which can be integrated into the multilayer material 1. Alternatively, the support can be a web of fibers comprising for example glass fibers, plant fibers or any other suitable fibers, which can be woven or non-woven.

The film 30, 30′ comprises a first component 31, or a combination of first components 31, which can form a set of particles (FIG. 4).

According to one particular embodiment, the particles consisting of the first component(s) 31 can be independent from one another. In particular, they can be mobile relative to each other, although in contact with each other. This embodiment is however not preferred.

According to another embodiment, the particles are interconnected, i.e. linked to each other at least by weak interactions maintaining their cohesion. Such cohesion can nevertheless allow their relative mobility. Stronger cohesion may be possible, which freezes the particles in relation to each other.

Preferably, the particles made up of the first component(s) 31 are integral with each other so as to form a rigid network of particles, suitable for giving the film 30, 30′ greater mechanical strength.

The particles mentioned here designate solid and integrity elements. They are not intended to fragment during the repair or manufacturing process of the material. The particles are preferably mono-structural, i.e. of homogeneous composition and structure. In this sense, the particles described here exclude vesicles and capsules as well as any equivalent product. These products in fact include an envelope and a content, the compositions of which differ. Their structure is in fact heterogeneous and not suitable for restoring the mechanical performance of the material.

The film 30, 30′ further contains one or more second components 32 forming a homogeneous assembly around the particles comprising the first component(s) 31. Thus, the first 31 and second 32 components form a two-phase mixture in which the particles of first component 31 are dispersed in the second component 32.

Preferably the first component(s) 31 are of the thermosetting type, meaning that they irreversibly adopt a hard and rigid polymerized state under the effect of specific reaction conditions, in particular under the effect of a heating operation. The first component(s) 31 may comprise for this purpose a set of monomers and one or more hardeners allowing their polymerization and/or their crosslinking. The first component(s) 31 may include other elements or additives depending on the uses and needs.

Preferably, the second component(s) 32 are of the thermoplastic type. That is to say, they reversibly adopt a viscous state under the effect of an increase in temperature and a solid state upon cooling. The combination of the first 31 and second 32 components leads to a solid mixture at ambient temperature, up to a determined threshold temperature and to a two-phase mixture when the temperature rises beyond this threshold, where the particles of first component 31 remain solid and where the second component(s) 32 form a continuous fluid phase. This biphasic system makes it possible to regenerate cohesion defects between layers or to prevent them.

According to one specific embodiment, the surface of the particles of the first component(s) 31 may comprise chemical functions capable of reacting with the constituents of one or the other of the first 10 and second 20 layers. Thus, the particles can establish chemical interactions with one or another of the adjacent layers, thus reinforcing mechanical cohesion. The first component(s) 31 may thus include free functions such as acids, amines, alcohols, silicon oxides, or any other function capable of reacting with constituents of the first 10 and/or second 20 layers. It may be advantageous to adapt the composition of the particles according to the nature of the adjacent layers so as to promote possible chemical interactions.

Alternatively, depending on the needs, the particles comprising the first component(s) 31 are chemically inert. Their advantage is then mainly or exclusively mechanical. For this purpose, they may include one or more components capable of reinforcing their mechanical resistance. Components such as carbon nanotubes may be included in the first components 31 for this purpose.

In addition to the composition of the particles of first component 31, or alternatively to their composition, their size is preferably controlled and homogeneous. For example, the diameter of the particles of first component 31 is preferably comprised between 0.1 μm and 20 μm, or between 0.1 μm and 15 μm. It can be considered advantageous if the first component(s) 31 are in the form of particles having an average diameter of between 0.1 μm and 0.5 μm, or between 0.5 μm and 1 μm, or between 1 and 2 μm or between 2 and 5 μm, or between 6 and 12 μm. The range of dimensions can be adapted to the nature of the adjacent layers, in particular to their porosity or their density, or to their composition or to other of their parameters. In particular, the range of dimensions characterizing the particles of the first component(s) 31 designates an average dimension with a given standard deviation. In this way, the particles are of uniform size. Selecting a given size range may also mean that at least a certain proportion of the particles, such as 70% or 80% or 90% or more, have dimensions corresponding to that size range. It can thus be considered that in a film 30, 30′, a proportion of 80% or 90% of the particles of the first component(s) 31 have a diameter of between 0.1 and 15 μm.

It is understood that the dimensions of the particles of the first component(s) 31 remain constant, or relatively constant under the effect of an increase in temperature. In particular, the particles remain intact and do not disintegrate in a temperature range corresponding to the temperatures involved in the self-repair or self-regeneration process. Their thermal expansion coefficient is in this case much lower than the thermal expansion coefficient of the second component(s) 32. It can preferably be 3 times, 10 times or 50 times smaller than that of the second component(s) 32. It can be less than the thermal expansion coefficient of the second component(s) 32 by a factor of 10, 100 or 1000 or more. The particles of first component 31 remain, for example, intact up to temperatures of the order of 150° C. or 180° C. or 200° C. or more. In particular, they remain intact at the glass transition temperatures of the second component(s) 32.

The size and/or size distribution of the particles of the first component(s) 31 may depend on one or more factors linked to their composition and the conditions of their polymerization. Preferably, the particles of the first component(s) 31 are formed in situ, in the presence of the second component(s) 32. For example, the first component(s) 31, intended to react together, are dispersed among the second component(s) 32 in the form of a liquid. They polymerize there under the effect of temperature and possible other reaction parameters while the second component(s) 32 remain in fluid form. The principle is a reaction-induced phase separation, also known as RIPS (Reaction Induced Phase Separation).

The particles of first component 31 do not strictly speaking have a melting temperature. They can nevertheless be characterized by a degradation temperature Td31 corresponding to a temperature from which onwards they lose their integrity and/or their possible interaction properties with each other, and/or their rigidity. According to one possible aspect, the degradation temperature can correspond to a transition of the material such as the glass transition, often designated Tg. In this case, the degradation temperature of the first component 31 corresponds to its glass transition temperature Tg31.

The second component(s) 32 take on plastic properties depending on the temperature. They are in this case characterized by a melting threshold temperature and/or a viscous transition temperature at which they pass from a solid state to a viscous state. For the purposes of this description, the second component(s) 32 are defined by their fluidization temperature Tf32, corresponding to the temperature at which the second component or components 32 become sufficiently fluid to allow self-regeneration or self-repair according to the terms of the present invention. Typically, the fluidization temperature Tf32 is of the order of 150° C. or lower, or of the order of 180° C. or of the order of 200° C. Preferably, it remains below 200° C., or even equal to or below 180° C. According to one advantageous mode, a temperature of the order of 140° C. or 130° C. is sufficient to give the second components 32 the fluidity adequate for the self-repair of the multilayer material. It is important that the fluidization temperature Tf32 of the second component(s) 32 remains lower than the degradation temperature Td31 of the particles of first component 31. Preferably the fluidization temperature Tf32 is lower than the degradation temperature Td31 by more than 10%, or even by more than 20%, more advantageously by more than 50%.

In multilayer materials 1, the film 30, 30′ being inserted between several other layers 10, 20, it is necessary that the fluidization temperature Tf32 of the second component(s) 32 remains significantly lower than the degradation temperature of the adjacent layers. In particular, the first layer 10 can act as a screen and limit the thermal conduction necessary for heating the film 30, 30′. It may be necessary under these conditions to heat to temperatures higher than the fluidization temperature Tf32 of the second component(s) 32, or to heat to temperatures close to the fluidization temperature Tf32 but for extended periods of time. Under these conditions, the fluidization temperature Tf32 of the second component(s) 32 is advantageously lower than the degradation temperature of the first layer 10, by at least 10%, or by at least 30%, or even by 50% or more. It is also preferably lower than the degradation temperature Td20 of the second layer 20, by at least 10% or 20% or more. It is therefore understood that the temperatures relating to the process described here, such as the fluidization temperature Tf32 and the degradation temperature Td31 correspond to the temperatures to which the film 30, 30′ is actually exposed when it is placed between the first 10 and second 20 layers.

In the case where one of the first 10 and second 20 layers comprises one or more thermoplastic components, it is preferable to maintain the fluidization temperature Tf32 of the second component(s) 32 lower than the fluidization temperature Tf10, Tf20 of the thermoplastics of the layers adjacent to limit their transformations during the self-repair or self-regeneration operation.

It is understood that in the case of a multilayer material 1, the self-regeneration or self-repair of the cohesion of the layers to one another must not generate degradation within the layers themselves. The film 30, 30′ allows self-regeneration or self-repair at temperatures which do not cause any damage to the other layers of the multilayer material 1.

The film 30, 30′ comprises a mixture of first 31 and second 32 components forming two distinct phases. In particular, the first component(s) form a thermoset and the second component(s) form a thermoplastic. The volume proportion of the first component(s) 31 and the second component(s) 32 is preferably greater than approximately 70% and less than approximately 90%. In other words, the ratio of first components 31/second components 32 is between 60/40 and 90/10, or between 70/30 and 90/10. More precisely, the thermosetting/thermoplastic ratio in the film 30, 30′ is between 60/40 and 90/10. In particular, the concentration of the first components 31 is adapted to maintain the corresponding particles in contact with each other, the space between them being filled by the second component(s) 32. The proportion of the first 31 and second 32 components can vary for example depending on the size of the particles. According to one particular embodiment, it may be advantageous in the case of particles with a size of the order of 5 μm or less, for the first component(s) 31 to be present in the film in volume proportions of more than 80% or more than 85%. In this way, the resistance of the film 30, 30′ can be increased as well as its self-regenerating or self-repairing properties of the layer cohesion.

Alternatively, for particle sizes of the order of 5 μm or less, it can be deemed more advantageous to limit the volume proportion of the first component(s) 31 to a value less than 80% or less than 75%. This can be particularly beneficial for promoting their dispersion, even at low temperatures such as below 180° C. or 150° C., or even below 120° C. or 100° C., or even 60° C. or less. The volume proportions of first 31 and second 32 components can also be determined depending on the nature of the first 10, 10′ and second 20 layers. In the case where one of the layers is an expanded material, such as a foam, of high porosity, the film can advantageously comprise a volume proportion of first component 31 greater than 80% or greater than 85% or close to 90%. The particle dimensions of the first component(s) 31 can alternatively or additionally be determined depending on the nature of one or the other of the first 10, 10′ and second 20 layers. Particles of larger diameters, such as 10 μm or 15 μm, may be favored in the case where one of the first 10, 10′ and second 20 layers is of high porosity. Smaller particle sizes may be favored in combination with layers of less porous material.

The thermosets constituting the first components 31 can be selected from Epoxy resins of all kinds (DGEBA, DGEBF, etc.), polyurethane resins, resins based on vinyl esters, phenolic type resins, novolak-type resins, as well as mixtures.

In the context of this description, the first component(s) 31, or the thermosets, designate all of the constituents forming the solid phase comprising the particles mentioned above. This set of constituents may include compounds having intrinsically no thermosetting properties but promoting the formation of particles and/or giving them other properties. The first or thermosetting component(s), as a whole, do not have thermoplastic properties.

The thermoplastics constituting the second component(s) 32 may be of the amorphous, semi-crystalline or crystalline type. They can be selected from polycaprolactone (PCL), polyetherimides (PEI), polyvinyl acetate (PVA), poly(vinyl butiral) (PVB), polybutyl succinate (PBS), polyethylene terephthalate (PET), polysulfones (PSU), polystyrene (PS), polylactic acid (PLA), polyethersulfone (PES), polyoxophenylene (PPO), acrylonitrile butadiene (ABS), acrylonitril styrene, methyl-acrylonitrile-butadiene-styrene methacrylate (MABS), polyethylene glycol (PEG), thermoplastic polyurethanes, polyoxomethylene (POM), polybutyrene terephthalate (PBT), polyphenylsulfone (PPSU), or copolymers (EMMA, EMAA, PEO/PEG, PVME) as well as their derivatives and mixtures.

In the context of this description, the second component(s) 32, or the thermoplastics, designate all of the constituents forming the homogeneous phase of the film 30, 30′ once manufactured, and whose viscosity can vary reversibly with the temperature. This set of constituents may include compounds having intrinsically no thermoplastic properties but promoting its formation or conferring other properties. The second or thermoplastic component(s) 32, as a whole, do not have thermosetting properties.

The expanded or foamed components include, for example, polymers such as PVC or any other foam, including metal foams.

Preferably, the film 30, 30′ is free of any other structuring compound such as fibers or equivalent structures. The first component(s) 31 are then the only structuring components of the film 30, 30′. In this context, a possible support on which the film 30, 30′, mentioned above, is placed, is not a structuring reinforcement but a simple support.

As indicated above, the materials constituting one or both of the first 10 and second 20 layers can be selected from plastics, composite materials such as carbon fibers or glass fibers, glasses, organic glasses, metals such as aluminum or metal alloys, plant fiber materials such as those based on cellulosic fibers, flax fibers, hemp fibers, expanded materials such as polymer foams or metal foams, or a combination of two or more of these materials. Expanded materials, and in particular foams, refer more specifically to porous or powdery materials. Materials based on cellulosic fibers more particularly designate cardboard structures, in particular honeycomb or comprising other types of cells. The honeycomb structures can nevertheless be composed of other materials such as synthetic polymers including para-aramids, phenolic, epoxy, and polyester resins.

According to an advantageous embodiment, the multilayer material 1 according to the present description comprises one or more first layers 10, 10′, preferably two first layers, of a compact material such as a plastic polymer or a composite material based on glass or carbon fibers, and a second layer 20 of an expanded material. A film 30 is placed between one of the first layers 10 and the second layer 20, preferably, two distinct films 30, 30′ are placed on either side of the second layer 20 between the second layer 20 and the first adjacent layers 10, 10′.

The multilayer material 1 according to the present description may comprise one or more distinct layers of adhesive agent either within one of the first 10, 10′ and second 20 layers, or interposed between the surface of one of the first 10, 10′ and second 20 layer and the film 30, 30′. The layer of adhesive agent can also be a support layer on which the film 30, 30′ can be deposited before being incorporated into the multilayer material 1.

The film 30, 30′ can have a density of between 30 and 500 g/m², preferably of the order of 50 to 300 g/m². Its thickness is preferably controlled and homogeneous. The thickness of the film 30, 30′ can be comprised between 60 and 1000 μm or between 60 and 300 μm, or between 80 μm and 250 μm, or of the order of 100 to 200 μm depending on needs. Alternatively, a thick film can be considered, with a thickness of around 500 μm to 1 mm. A film of intermediate thickness can also be considered. In this case, its thickness is of the order of 310 μm to 490 μm.

The present description also covers a method of manufacturing a multilayer material 1. In the present manufacturing process, the first 10 and second 20 layers are prepared separately, at least partially. The first 31 and second 32 components of the film 30, 30′ as described above are mixed so as to prepare the film independently of the first 10 and second 20 layers between which it is intended to be interposed. The film 30, 30′ is then placed between two layers of the multilayer material 1, namely between a first 10 and second 20 layer. The assembly can be subjected to a heating step making it possible to polymerize one or the other or several of the layers of the multilayer material 1 in the case where they require such polymerization. For example, the multilayer material 1 can be placed at a temperature comprised between approximately 60° C. and 200° C., or even up to 300° C. or 400° C. if necessary, to allow its different constituents to react. The temperature range can of course be adapted to the type of the different materials constituting the multilayer material 1. Temperatures can be limited to a range of 60° C. to 100° C. or 80° C. to 150° C., or 100° C. to 200° C. Polymerization times are also variable and adapted to the materials used. They can be comprised between 1 or 5 minutes and 5 days. They can furthermore be adapted to the temperatures applied. For example, temperatures of around 60 to 80° C. can be applied for several hours or several days. Higher temperatures, of the order of 150° or 200° C., will preferably be applied for shorter periods, from 30 to 90 minutes or a few hours. Higher temperatures of the order of 300° C. or 400° C. can for example be applied over periods of a few minutes, i.e. approximately 5 to 15 minutes. Other conditions may be considered depending on the results to be obtained.

Alternatively, the first 10 and second 20 layers are already preformed in one or more preliminary steps and only require one assembly step with the film 30, 30′. The heating step makes it possible in all cases to establish the adhesion of the adjacent layers by means of the film 30, 30′. The film 30, 30′ can be placed alone between the layers of the multilayer material or in combination with a support layer. For example a layer of polymer, such as a woven polymer with a density of around 10 to 50 g/m², can be provided for this purpose. The chosen support may, for example, have a density of between 10 and 25 g/m², from 25 to 35 g/m² or from 35 to 50 g/m² depending on needs.

The manufacture of the film 30, 30′ therefore comprises a first step consisting of mixing one or more of the second components 32 in the first component(s) 31. The mixing is preferably carried out in the liquid phase or in the viscous phase. This does not exclude mixing the second components 32 or part of the second components 32 with the first components 31 in powder form or in other forms, and heating the mixture so as to fluidize or liquefy it, at least in part. In the case where the second components 32 comprise monomers and a hardener, the monomers can be solubilized in the first component(s) 31 before the hardener. In the case where the first 31 and/or the second 32 components include other additives, they can be added in a staggered manner, one after the other and in an optimal order.

The mixture of the first 31 and second 32 components is then placed on a support surface. The mixture is at this stage preferably in a viscous state to facilitate spreading. It can also be liquid. The support surface may be a polymer film adapted to be transferred into the multilayer material 1 in combination with the film 30, 30′. Alternatively, the support surface is limited to a work surface on which the film 30, 30′ can be shaped. The film can be spread using a suitable tool, such as a roller or any equivalent. In the context of industrial production, the film can be stretched in a rolling mill or any other device adapted to the production of a homogeneous film, in combination with a support layer or not. According to a variant, the film 30, 30′ can be placed directly on a surface of one of the first 10, 10′ and second layers, then be covered by another layer and thus be sandwiched between a first 10, 10′ and second 20 layers.

The process for producing the film 30, 30′ may include a polymerization or partial polymerization step at a temperature above ambient temperature. This polymerization or partial polymerization can provide a texture and a structure which facilitates its handling. Such a step can be carried out for example at temperatures lower than 100° C. or lower than 80° C., or even of the order of 40° C. to 60° C. for periods of the order of a few minutes up to about ten or twenty minutes. The polymerization or partial polymerization step can be carried out before placing the film 30, 30′ on a support surface or just after. A polymerization or partial polymerization step can be carried out by methods other than raising the temperature. For example, polymerization under light irradiation, such as under UV, can be considered. Advantageously, such a polymerization or partial polymerization step can be selective for the first 31 or the second 32 components. Preferably, in the case where such a polymerization or partial polymerization step is applied, the film remains homogeneous.

It may not be useful to polymerize the film 30, 30′ before its incorporation into the multilayer material 1. It can thus be handled either directly, or using the support film if necessary, and be placed on one of the layers of the multilayer material. A second layer is then applied there so as to enclose the film 30, 30′ between a first 10, 10′ and a second 20 layer of the multilayer material 1. In this case, the step of placing the multilayer material at a temperature between about 60° C. and about 200° C. or any other temperature range previously mentioned, for a suitable duration such as those previously mentioned, contributes to generating the two distinct phases of the film 30, 30′, and in particular the particles of first components 31 dispersed in the homogeneous medium of the second component 32. This curing step, applied once the film is placed in the multilayer material, therefore induces a phase separation.

The method of manufacturing the multilayer material 1 may comprise several preliminary and independent steps of forming several films 30, 30′ of different compositions or of the same composition. The different films 30, 30′ are then incorporated between different layers of the multilayer material 1. In the case where the multilayer material 1 is a sandwich material comprising two first skin layers 10, 10′ and a second core layer 20, two films 30, 30′ can be produced and placed between the first skin layers 10, 10′ and each of the faces of the second core layer 20. According to a particular method of preparation, one or more of the first layers 10, 10′ comprises or is constituted of a composite material

It is understood that the heating and/or polymerization operations of the film 30, 30′ and/or the multilayer material 1 do not degrade any of the layers of the multilayer material nor the film(s) 30, 30′. In particular, the film 30, 30′ acquires or retains its properties as a self-repairing or self-regenerating film.

The present description also covers a method of self-repair or self-regeneration of a multilayer material 1 in particular with regard to possible layer adhesion defects. To this end, the multilayer material 1 is heated, for example using a hot air gun or infrared irradiation or any other suitable heating means. The heating temperature depends on the constituents of the multilayer material 1, and in particular on those of the first layer 10, 10′ covering the film 30, 30′ and on those constituting the film 30, 30′. The temperature is maintained at a value close to the fluidization temperature Tf32 of the second component(s) 32 during a duration of the order of a few minutes, typically of the order of 2 to 10 minutes, or 3 to 8 minutes depending on the materials considered. Longer heating times can be applied, in the range of 15 to 60 minutes. The temperature is in all cases maintained at a value lower than the degradation temperature of the first components 31 and the other constituents of the multilayer material 1.

Local heating may be sufficient. According to an alternative method, the multilayer material 1, or the entire object comprising the multilayer material 1, is heated, for example by placing it in an oven at a controlled temperature for a predetermined duration. Temperature gradients can be provided.

The self-repair or self-regeneration method is characterized by the absence of modification of the multilayer material 1, and in particular by the absence of cutting, addition of material, removal of material, shaping, polishing etc. usually necessary. The method therefore consists exclusively of a heating operation under suitable conditions.

According to a particular embodiment, one or more of the layers of the multilayer material 1 comprises or is constituted of a composite material suitable for self-repair or self-regeneration. For example, a material such as those described in patent application WO2020049516. In this case, a self-regeneration or self-repair step makes it possible to repair both the core defects of the composite materials and the adhesion of the different layers to each other.

This description further covers a method of monitoring and maintaining equipment made from multilayer materials 1, or comprising such materials. For example, a localized or generalized heating operation can be planned at regular time intervals, determined according to different parameters such as the intensity of use of the object, occasional intensive use, characteristics of the materials used and any other relevant parameter. Thus, it is possible not to dismantle, or only partially dismantle, multilayer materials 1 from the object they constitute.

This description also covers any object made of or comprising a multilayer material 1 as described herein. Such an object can for example be selected from aeronautical equipment, wind power equipment, marine equipment, medical equipment, automotive equipment, aerospace equipment, sports equipment material. More specifically, the object can be a wind turbine blade, a boat hull, an airplane wing, a ski, a vehicle body such as a refrigerated vehicle or any other element.

### Experimental Part

### Example 1: Repair Test

The three sandwich materials M1, M2 and M3 are produced to establish comparative layer adhesion tests, each of the materials contains a layer of prepreg-type composite material (Healteach® E-Glass Twill Preg, Healtech® E-glass TW390 1250 390 g/m²) and a core layer made of SAN type foam (Corecell M80 From Gurit Ltd).

Material M1: Additionally comprises a self-repairing film as described in the present invention with a density of 200 g/m² placed between the layer of composite material and the body foam.

Material M2: Does not contain self-healing film or adhesive film.

Material M3: Contains a conventional adhesive film (VTC 401 produced by SHD Composite Ltd), placed between the composite material layer and the body foam.

The materials M1, M2 and M3 are polymerized at 140° C. for 3 hours.

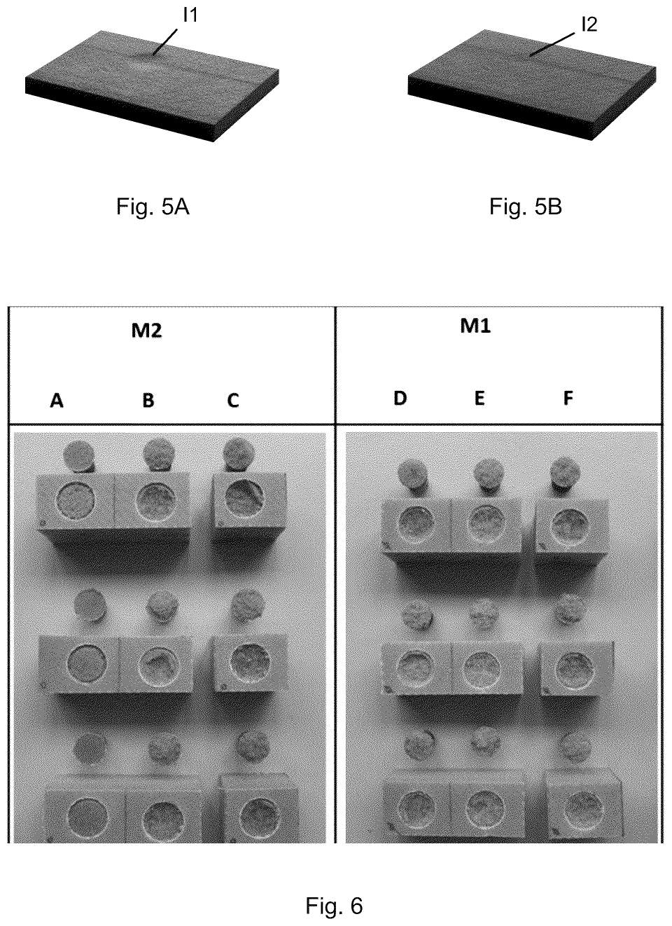

An impact of 2.4 J is produced on a surface of materials M1, M2 and M3 using an impactor with a diameter of 70 mm. FIG. 5A shows the impact 11 obtained on the surface of the multilayer material M1.

Materials M1, M2 and M3 are heated at impact 11 by a hot air gun to 150° C. for 8 to 10 minutes. FIG. 5B shows the material M1 after heating and the impact point 12, whose visual defect has disappeared.

### Example 2: Adhesion Test

An adhesion test is carried out on materials M1 and M2 using an Elcometer 506 type traction machine, test diameter 20 mm, until the skin layer separates from the multilayer material. The qualitative aspect is then observed.

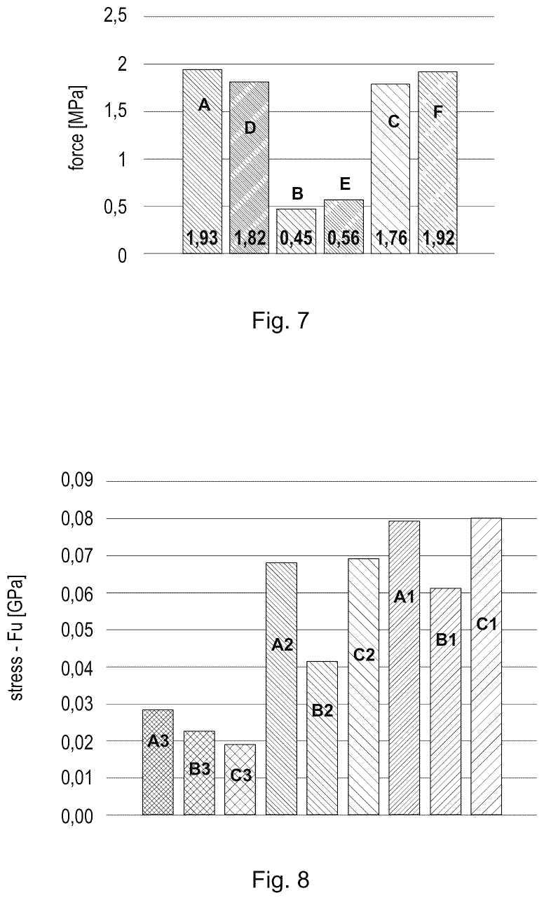

For each of the materials M1 and M2, a tensile test is carried out in the native state (A, D), after impact (B, E) and after repair at 140° for 8 to 10 minutes (C, F). FIG. 6 shows the visual results. FIG. 7 shows the comparative adhesion strengths. The adhesion of the layers appears better with the film (M1) than without the film (M2) after impact and after repair. The repair efficiency is 88% without the film and 108% with the film.

### Example 3: Mechanical Resistance

The sandwich materials M1′, M2′ and M3′ are prepared from a skin layer identical to that of the M1, M2 and M3 materials, and with a PET type body layer (Airex T92).

Material M1′: Additionally comprises a self-repairing film as described in the present invention with a density of 200 g/m² placed between the layer of composite material and the body foam.

Material M2′: Contains neither self-repairing film nor adhesive film.

Material M3′: Contains a conventional adhesive film (VTC 401 produced by SHD Composite Ltd), placed between the layer of composite material and the body foam.

The materials M1′, M2′ and M3′ are polymerized at 140° C. for 3 hours.

An impact of 2.4 J is produced on a surface of materials M1, M2 and M3 using an impactor with a diameter of 70 mm. For each of the materials M1′, M2′ and M3′, a mechanical resistance test is carried out in the native state (A1, B1, C1), after impact (A2, B2, C2) and after repair at 140° for 8 to 10 minutes (A3, B3, C3). FIG. 8 shows the corresponding resistances.

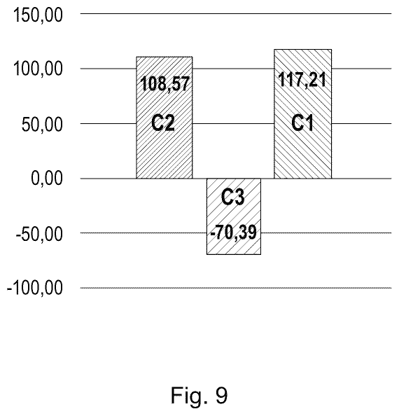

The repair effectiveness is shown for each of the repaired materials M1′ (C1), M2′ (C3) and M3′ (C2) in FIG. 9. The effectiveness of the repair appears more effective for the material M1′, comprising a film according to the present description.

### Reference Numbers Used in the FIGS

1 Multilayer material
10, 10′ First layer
20 Second layer
30, 30′ Film
31 First components
32 Second components
40, 40′ Adhesive agent layer
E10 Thickness of the first layer
E20 Thickness of the second layer
P10 Porosity of the first layer
P20 Porosity of the second layer
Td10 Degradation temperature of the first layer
Td20 Degradation temperature of the second layer
Td31 Degradation temperature of the first components
Tf32 Fluidization temperature of the second components

1. Multilayer material comprising at least one first layer and at least one second layer associated with one another by means of one or more films interposed between said first and second layers, said at least one first layer having a degradation temperature (Td10) and said at least one second layer having a degradation temperature (Td20), said one or more films comprising one or more first components forming, or capable of forming, a set of solid particles and having a degradation temperature, (Td31) and one or more second components, forming or capable of forming a homogeneous assembly around the particles of the first component(s), wherein the second component(s) have a fluidization temperature (Tf32) lower than the degradation temperature (Td31), of the first component(s) and lower than the degradation temperature (Td10, Td20) of one or more of the first and second layers, and the dimension of at least 70% or at least 80%, or from 70% to 90% of the particles of the first component(s) is comprised between 0.1 micrometers and 15 micrometers.

2. Material according to claim 1, said at least one first layer comprising a material selected from plastics, composite materials such as those comprising carbon fibers, glass fibers, or natural fibers, glasses, metals or alloys such as aluminum, or a combination of two or more of these elements.

3. Material according to claim 1, said at least one second layer comprising a material selected from expanded materials such as foams, or three-dimensionally structured materials such as honeycombs, or a natural material such as wood.

4. Material according to claim 1, comprising two first layers and a second layer arranged between the two first layers, and two films arranged between each of the two first layers and the second layer.

5. Material according to claim 1, said one or more first components forming a thermosetting product and said one or more second components forming a thermoplastic product.

6. Material according to claim 5, said thermosetting product comprising an epoxy resin, a polyurethane resin, a polyester resin, a resin based on vinyl ester, a resin based on phenolic products, a polyimide resin, a novolak-type resin or one of their combinations.

7. Material according to claim 5, said thermoplastic product comprising a component selected from PCL, PEI, EMMA, PVA, PVB, PBS, EMAA, PET, PSU, PS, PLA, PES, PPO, ABS, SAN, MABS, PEG, POM, PBT, PEO, PPSU, PVME or one of their combinations.

8. Material according to claim 1, further comprising one or more layers of an adhesive of composition different from that of the film(s).

9. Material according to claim 1, the volume ratio of the first component(s) and the second component(s) being between 60/40 and 90/30.

10. Material according to claim 1, the thermal expansion coefficient of the second component(s) being greater than the thermal expansion coefficient of the first component(s) by a factor of 10 or 1000 or greater.

11. Material according to claim 1, said one or more films being free of reinforcing fibers.

12. Material according to claim 1, said degradation temperature of the first component(s) (Td31) being equal to the glass transition temperature (Tg31).

13. Method of manufacturing a multilayer material according to claim 1, comprising a separate step of mixing the first component(s) with the second component(s) so as to produce one or more homogeneous films, to arrange said one or more homogeneous films between at least one first layer and at least one second layer, then to cure the assembly consisting of the homogeneous film(s) and at least one first layer and at least one second layer at a temperature and for a duration adapted to ensure that the first component(s) irreversibly form particles and in that the second component(s) form a continuous phase around the particles.

14. Method for self-repairing a multilayer material according to claim 1, wherein the cohesion of the adjacent layers is defective at least partially, the method comprising exclusively a step of heating to a temperature equal to or greater than the fluidization temperature (TF32) of the second component(s) and lower than the degradation temperature of the first component(s) and to the degradation temperature (Td10, Td20) of one or more of the first and second layers.

15. Method of maintaining or repairing an object comprising a multilayer material according to claim 1, the method comprising a step of heating the object or said multilayer material at regular time intervals, determined according to parameters such as the intensity of use of the object and the properties of said material.

16. Object comprising or being constituted of a material according to claim 1, the object being selected from aeronautical equipment, wind power equipment, marine equipment, medical equipment, automotive equipment, aerospace equipment, industrial production equipment or sports equipment material.
